(19) United States
(12) Patent Application Publication
(10) Pub. No.: US 2025/0251052 A1
(43) Pub. Date: Aug. 7, 2025

(54) FAUCET INCLUDING FLUID JUNCTION ASSEMBLY WITH FLOW LIMITER

(71) Applicant: ASSA ABLOY Americas Residential Inc., New Haven, CT (US)

(72) Inventors: Gerardo Sandoval Ruiz, Chino, CA (US); Jan Christopher van Leyen, Mission Viejo, CA (US)

(21) Appl. No.: 19/041,781

(22) Filed: Jan. 30, 2025

Related U.S. Application Data
(60) Provisional application No. 63/548,925, filed on Feb. 2, 2024.

(51) Int. Cl. F16K 11/00; E03C 1/04; F16K 31/44

(52) U.S. Cl. CPC F16K 19/006; E03C 1/04; F16K 31/44

(57) ABSTRACT

A faucet assembly including a fluid junction assembly is disclosed. The fluid junction assembly includes an inlet portion configured to receive a supply fluid and an outlet portion configured to output the supply fluid. The fluid junction assembly further includes a valve assembly positioned along a fluid path between the inlet portion and the outlet portion. The valve assembly has an open state allowing fluid flow when the supply fluid is flowing from the inlet portion toward the outlet portion and a closed state limiting fluid flow when the supply fluid is not flowing from the inlet portion toward the outlet portion. The fluid junction assembly may be positioned outside a faucet body, for example at an underbody location as installed.

### CROSS-REFERENCE TO RELATED APPLICATIONS

This application claims the benefit of U.S. Patent Application Ser. No. 63/548,925, filed on Feb. 2, 2024.

### BACKGROUND

There are a variety of different types of faucet assemblies. Certain faucet assemblies use a valve cartridge to control the flow of fluid between fluid supplies and fluid outlets. In such faucet assemblies, it is common for the valve cartridge to be positioned within a faucet body and be adjustable via a handle. The valve cartridge may receive one or more water supply lines (e.g., a hot and cold water supply line, or only one such line) and a supply line downstream of the cartridge may be routed out of the faucet body. A separate faucet connection assembly, for example in the form of a fluid junction formed in the shape of a u-joint connection assembly positioned at an underbody position (e.g., below a countertop or other mounting location of the faucet body), connects the supply line to an outlet line, e.g., a spout tube which leads through the faucet spout to the faucet outlet or sprayhead.

Pressure changes can occur within such faucet assemblies as a result of starting or stopping flow. Sudden pressure changes can have a variety of impacts, including vibration or noise, which may have a detrimental effect on the user experience of such faucet assemblies.

### SUMMARY

In general terms, this disclosure is directed to a faucet that includes a fluid junction assembly having a flow limiter. Such a flow limiter may, in some instances, be biased toward a closed position, but configured to open to allow fluid flow when a cartridge valve is open or activated. The fluid junction may be positioned external to a faucet body, for example as part of an underbody assembly. The flow limiter may include a valve that slows or stops water flow and prevents or reduces backpressure when a valve cartridge is manually operated to halt fluid flow, thereby reducing or eliminating unwanted noise or vibration that might occur when a user turns off a water supply at the valve cartridge.

In an example aspect, a fluid junction assembly for a faucet assembly includes a housing having an inlet portion configured to receive a supply fluid and an outlet portion configured to output the supply fluid. The fluid junction assembly further includes a valve assembly positioned along a fluid path between the inlet portion and the outlet portion, the valve assembly having an open state allowing fluid flow when the supply fluid is flowing from the inlet portion toward the outlet portion and a closed state limiting fluid flow when the supply fluid is not flowing from the inlet portion toward the outlet portion.

In a further example aspect, a faucet assembly includes a faucet body. The faucet body includes a valve cartridge and an outlet, the valve cartridge connecting to a fluid supply, the valve cartridge configured to control flow of a supply fluid from the fluid supply to the outlet, the valve cartridge having an activated state allowing the supply fluid to flow toward the outlet and a deactivated state preventing the supply fluid from flowing toward the outlet. The faucet assembly further includes a fluid junction assembly. The fluid junction assembly includes a housing having an inlet portion and an outlet portion, and a valve assembly positioned within the housing. The valve assembly is fluidically connected to the inlet portion and the outlet portion and includes a stopper. The stopper has an open state allowing the supply fluid to flow between the inlet portion and the outlet portion when the valve cartridge is in the activated state and a closed state limiting a fluid flow between the inlet portion and the outlet portion when the valve cartridge is in the deactivated state, the stopper being spring biased toward the closed state. The faucet assembly further includes a supply pipe extending between the valve cartridge and the inlet portion of the housing, the supply pipe configured to carry the supply fluid from the valve cartridge to the housing. The faucet assembly also includes an outlet pipe extending between the outlet portion of the housing and the outlet of the faucet body, the outlet pipe configured to carry the supply fluid from the housing to the outlet.

In a third example aspect, a method for limiting fluid flow within a faucet assembly is disclosed. The method includes, in response to reducing a flow of supply fluid within a faucet assembly between a supply pipe and an outlet, moving a stopper from an open state toward a closed state as a forward pressure through a fluid path created by the flow of supply fluid decreases below a spring force of a spring member attached to the stopper, the spring member configured to bias the stopper toward the closed state, the stopper positioned within a housing spaced apart from a faucet body of the faucet assembly and positioned along a fluid path between the supply pipe and the outlet.

### BRIEF DESCRIPTION OF THE DRAWINGS

FIG. 1 is a perspective view of an example faucet assembly in accordance with the principles of the present disclosure.

FIG. 2 is a front view of the faucet assembly of FIG. 1.

FIG. 3 is a first side view of the faucet assembly of FIG. 1.

FIG. 4 is a second side view of the faucet assembly of FIG. 1.

FIG. 5 is the second side view of the faucet assembly of FIG. 4 with the faucet body removed.

FIG. 6 is a perspective view of an example valve cartridge in accordance with the principles of the present disclosure.

FIG. 7 is a front view of an example fluid junction assembly having a flow limiter in accordance with the principles of the present disclosure.

FIG. 8 is a perspective view of an example housing in accordance with the principles of the present disclosure.

FIG. 9 is a cross-sectional side view of the housing of FIG. 8.

FIG. 10 is an upper exploded perspective view of an example valve assembly in accordance with the principles of the present disclosure.

FIG. 11 is a lower exploded perspective view of the valve assembly of FIG. 10.

FIG. 12 is a perspective view of an example supply adapter in accordance with the principles of the present disclosure.

FIG. 13 is a perspective view of an example retainer in accordance with the principles of the present disclosure.

FIG. 14 is a cross-sectional side view of an example fluid junction assembly including a flow limiter in accordance with the principles of the present disclosure.

FIG. 15 is a cross-sectional view of another example fluid junction assembly including a flow limiter in accordance with the principles of the present disclosure.

FIG. 16 is an example fluid flow diagram when an example valve assembly is in a closed state in accordance with the principles of the present disclosure.

FIG. 17 is an example fluid flow diagram when an example valve assembly is in an open state in accordance with the principles of the present disclosure.

FIG. 18 is a schematic representation of an example flow limiting operation in accordance with the principles of the present disclosure.

FIG. 19 is a schematic representation of an example flow limiting operation in accordance with the principles of the present disclosure.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

References in the specification to “one embodiment,” “an embodiment,” “an example,” “certain examples,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

The disclosure relates generally to faucet assemblies. For example, this disclosure may relate, in certain embodiments, to a faucet having a fluid junction assembly that includes a flow limiter. In general, a flow limiter includes a valve positioned between a supply line and an outlet line of a faucet. In certain examples, the flow limiter acts to limit, attenuate, dampen, stop, or prevent the flow of fluid between the supply line and the outlet line (e.g., at the fluid junction) in response to opening or closing an upstream valve.

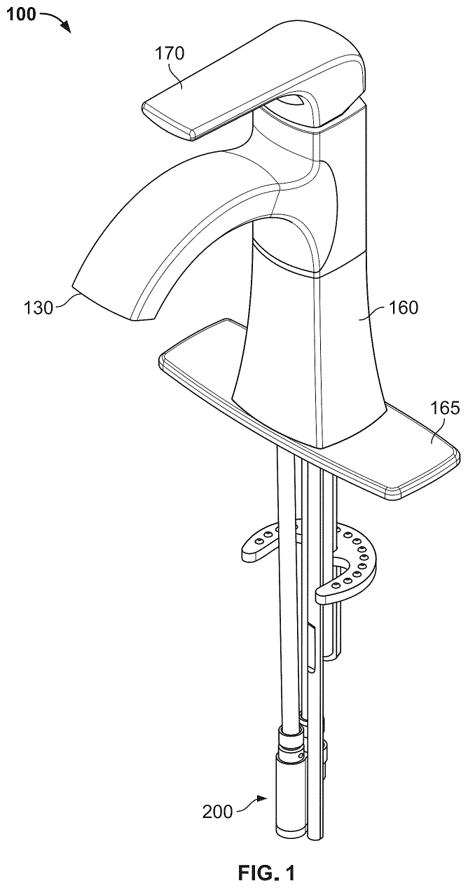

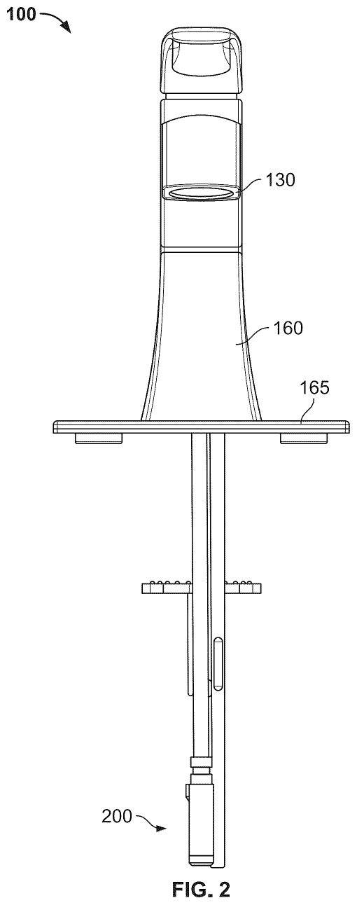

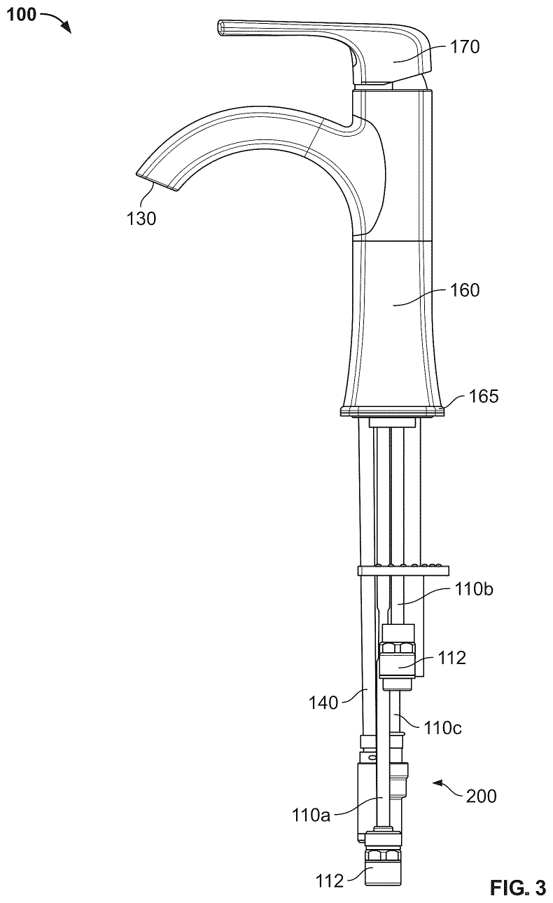

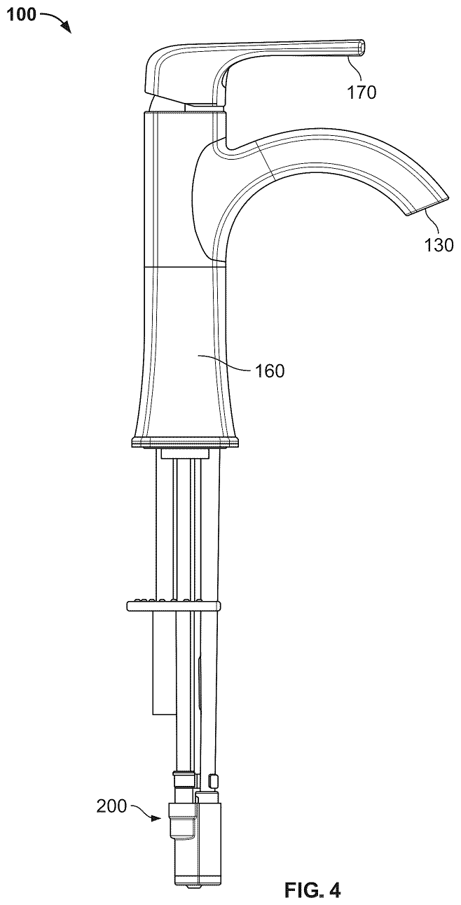

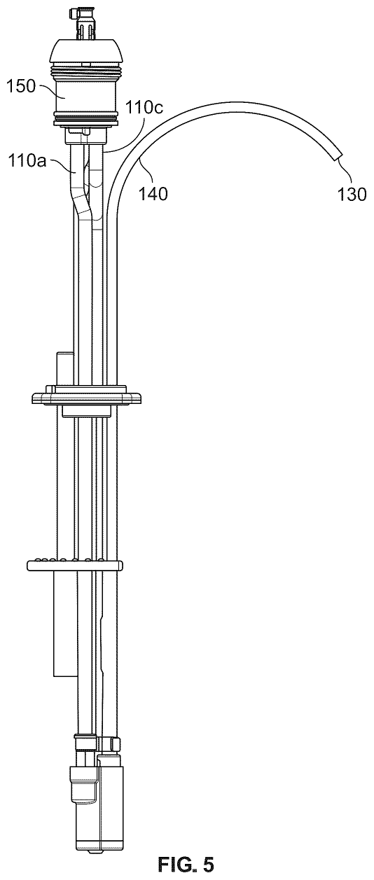

FIGS. 1-4 show an example faucet assembly 100 that includes a fluid junction assembly 200. In certain examples, the faucet assembly 100 includes a faucet body 160 with a handle 170. The faucet assembly 100 may also include a supply pipe 110 and an outlet pipe 140 with a valve cartridge 150 (shown in FIG. 5) in between. The valve cartridge 150 may be held within the faucet body 160. In the example shown, the valve cartridge 150 is connected to the faucet handle 170, which is manually operable to control the flow of fluid from the supply pipe 110 through the outlet pipe 140 and to an outlet 130, also referred to herein as a spout.

In certain examples, the faucet assembly 100 includes more than one supply pipe 110. In the example shown on FIGS. 1-4, the faucet assembly 100 includes a first supply pipe 110a and a second supply pipe 110b that are designed to connect to first and second fluid supplies of a building through supply line connectors 112. In certain examples, one supply is for hot water and a second supply is for cold/ambient water. In the example shown, a third supply pipe 110c extends from the valve cartridge 150 to the fluid junction assembly 200. In certain examples, the third supply pipe 110c carries a mixture of fluid from the first supply pipe 110a and the second supply pipe 110b. The mixture of fluid may be adjustable based on a position of the valve cartridge 150. Other configurations are possible. In certain examples a single supply pipe 110 is used.

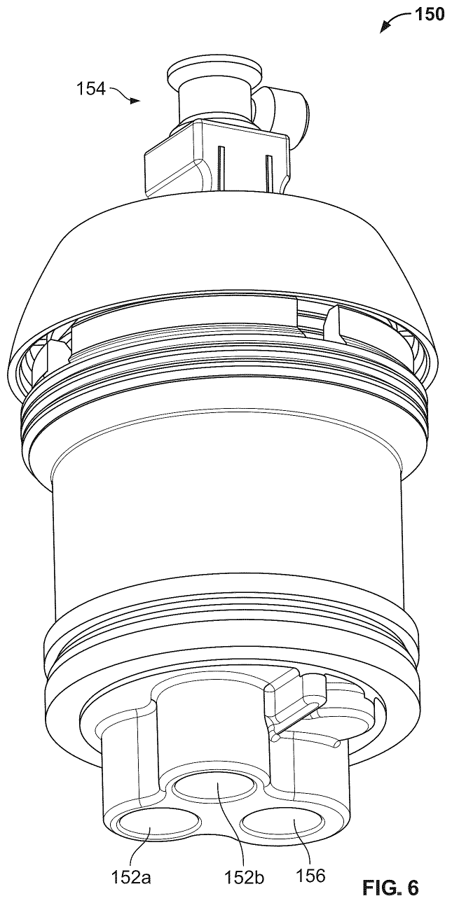

The valve cartridge 150 controls the flow of fluid from one or more fluid supplies running into the supply pipes 110. The valve cartridge 150 includes at least one cartridge inlet 152 and at least one cartridge outlet 156. The valve cartridge 150 includes at least an activated state and a deactivated state. In the activated state, the valve cartridge 150 allows the flow of fluid through the valve cartridge 150 and toward the outlet 130. The activated state (also referred to as an open state) may range from a minimal flow to an unrestricted flow of the fluid from the supply. In the deactivated state (also referred to as a closed state), the valve cartridge 150 prevents or stops the flow of fluid through the valve cartridge 150, which in turn prevents or stops the flow of fluid from the outlet 130. The activated and deactivated states may be controlled by a valve 154 that can be adjusted by the handle 170 of the faucet assembly 100. In certain examples, the valve cartridge 150 can adjust the ratio of fluid flow from the two supplies. In the example shown in FIGS. 5 and 6, the valve cartridge 150 includes a first cartridge inlet 152a and a second cartridge inlet 152b where the first cartridge inlet 152a provides connection between the first supply pipe 110a and the valve cartridge 150, and the second cartridge inlet 152b provides connection between the second supply pipe 110b and the valve cartridge 150. The cartridge outlet 156 connects to the supply pipe 110c which carries the supply fluid, sometimes mixed, from the valve cartridge 150 toward the outlet 130 when the valve cartridge 150 is in the activated state.

In certain examples, the fluid junction assembly 200 is positioned downstream of the valve cartridge 150. The fluid junction assembly 200 is designed to allow flow of fluid, both gas and liquid, in response to activation of the valve cartridge 150, to the outlet 130. In accordance with the present disclosure, the fluid junction assembly 200 includes a flow limiter, e.g., to limit or dampen the flow of fluid, both gas and liquid, in response to the deactivation of the valve cartridge 150. Fluid, as an example, may include supply fluid flowing from a fluid supply, or fluid may include gas held within the faucet assembly 100. Many variations of the fluid junction assembly 200 are possible.

In the example shown, the fluid junction assembly 200 is positioned below a base portion 165 of the faucet assembly 100. That is, when the faucet assembly 100 is installed at a surface, such as a countertop, the fluid junction assembly 200 may be positioned below the mounting surface. The faucet assembly 100 may be installed onto a surface using any of a variety of attachment mechanisms; in some examples, a threaded shank may extend downward from the faucet assembly 100 and through an aperture in the surface, and may be affixed by way of a threaded nut or other fixing mechanism positioned below the surface and affixed to the threaded shank. Other attachment mechanisms are possible as well.

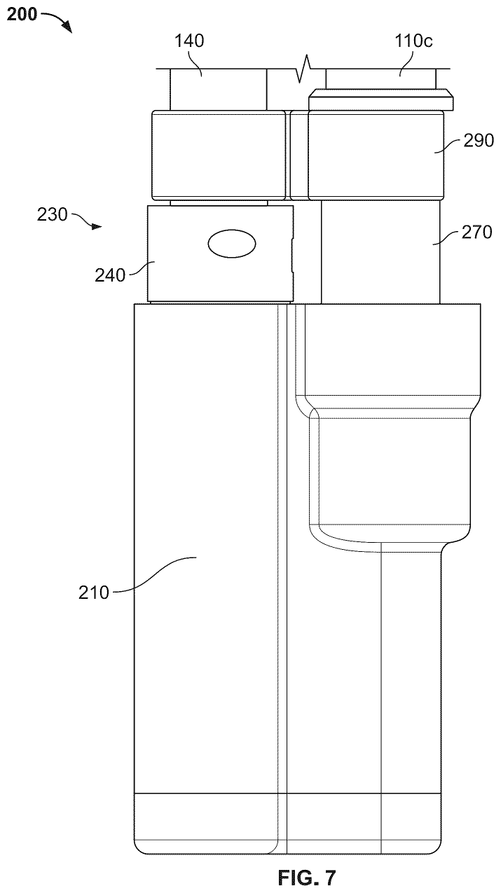

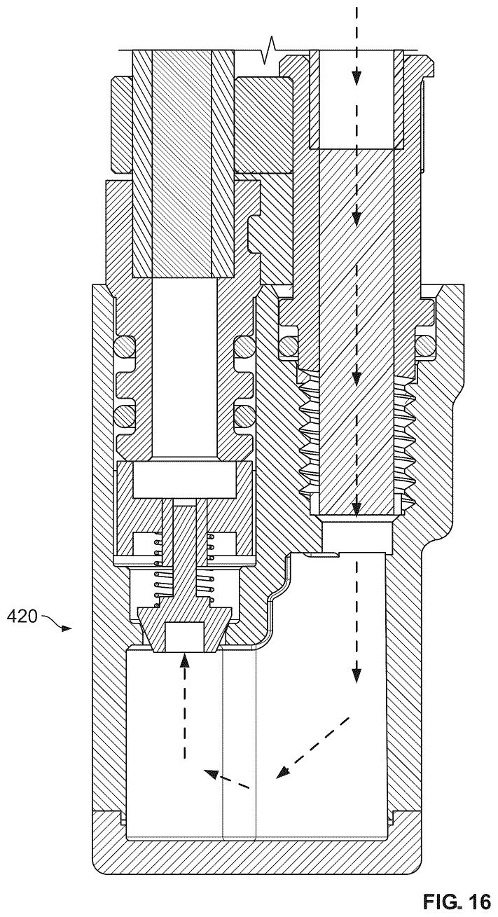

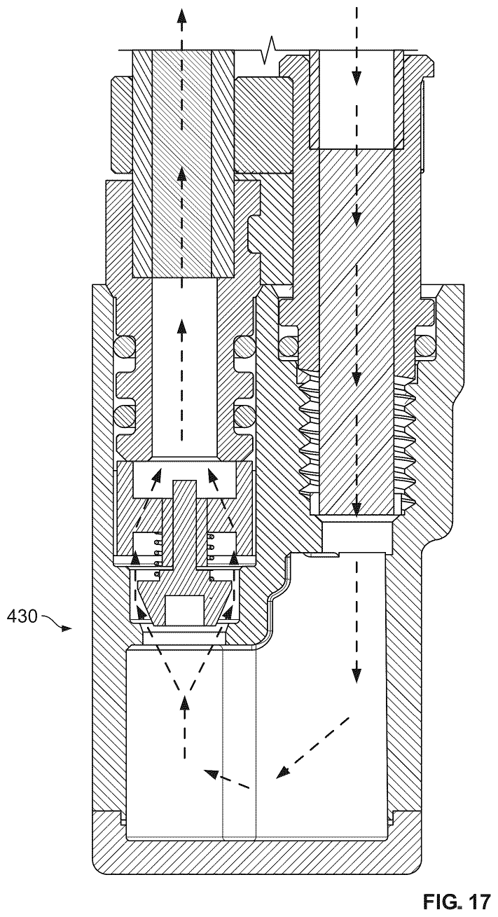

FIG. 7 shows an example fluid junction assembly 200 that includes a housing 210, a valve assembly 230, a supply adapter 270, and a retainer 290. The valve assembly 230 may be positionable in an open state 430 and a closed state 420 (shown in FIGS. 16 and 17), where the valve assembly 230 moves to the open state 430 in response to the valve cartridge 150 moving to the activated, or open, state, and, conversely, the valve assembly 230 moves to the closed state 420 in response to the valve cartridge 150 moving to the deactivated, or closed, state. Specific components of the fluid junction assembly 200 will be discussed in turn.

The housing 210 provides a space between the valve cartridge 150 and the outlet 130 for the valve assembly 230 to be held and be fluidically connected to the supply fluid. In certain examples, the housing 210 includes an inlet portion 211 and an outlet portion 212.

In the example shown, the inlet portion 211 is an opening into the housing 210 to receive a supply pipe 110, sometimes through a supply adapter 270. The inlet portion 211 may have a tapered or shaped edge on the exterior surface to facilitate insertion of the supply pipe 110 or supply adapter 270. In certain examples, the valve assembly 230 is located at least partially in the outlet portion 212 of the housing 210 when in an assembled state. The valve assembly 230 is fluidically connected to the inlet portion 211 and the outlet portion 212. The inlet portion 211 extends between an exterior surface of the housing 210 and an interior chamber 229 of the housing 210.

In the example shown, the outlet portion 212 extends between an exterior surface of the housing 210 and the interior chamber 229. The interior chamber 229 fluidically connects the inlet portion 211 with the outlet portion 212. The interior chamber 229 may take any shape and may facilitate directional change in the fluid flow. In certain examples, the interior chamber 229 is a U-shape that facilitates a 180-degree directional change of fluid flowing through the housing 210, such that an inlet flow is parallel to an outlet flow. The inlet flow and outlet flow define a flow direction.

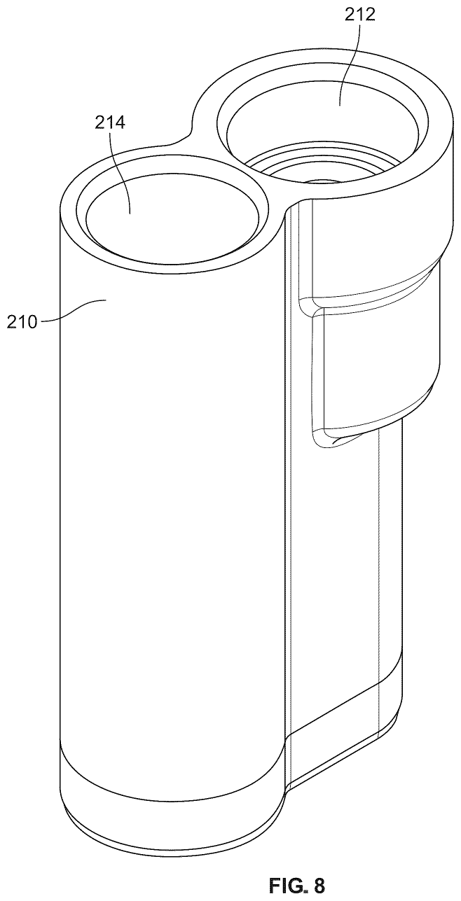

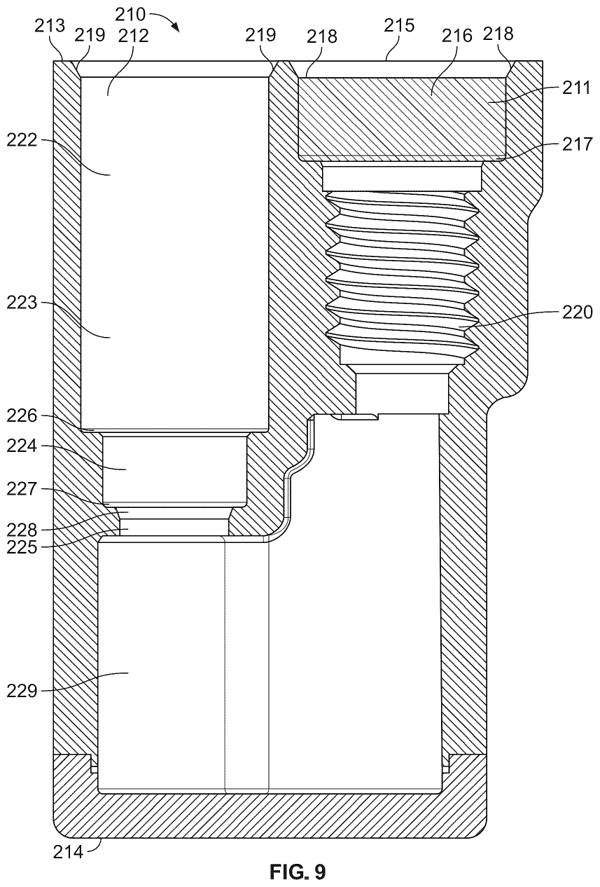

FIGS. 8, 9, and 14 show an example of the housing 210. In housing 210, the inlet portion 211 further defines an inlet cavity 215 that extends from a top side 213 and continues toward a bottom side 214 of the housing 210. The inlet cavity 215 includes a first section 216 that extends between the top side 213 and a second section 220.

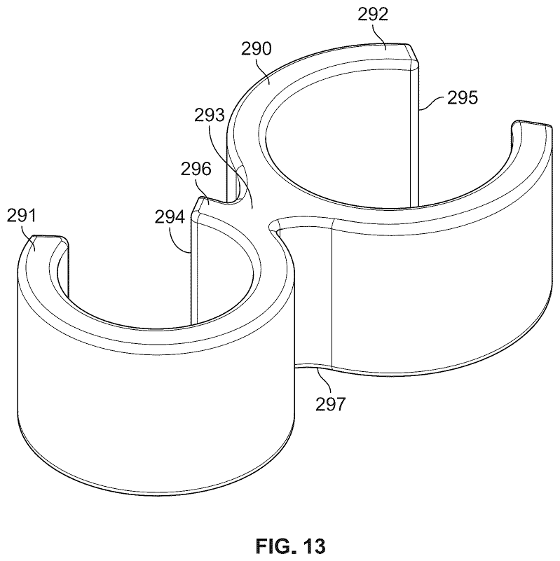

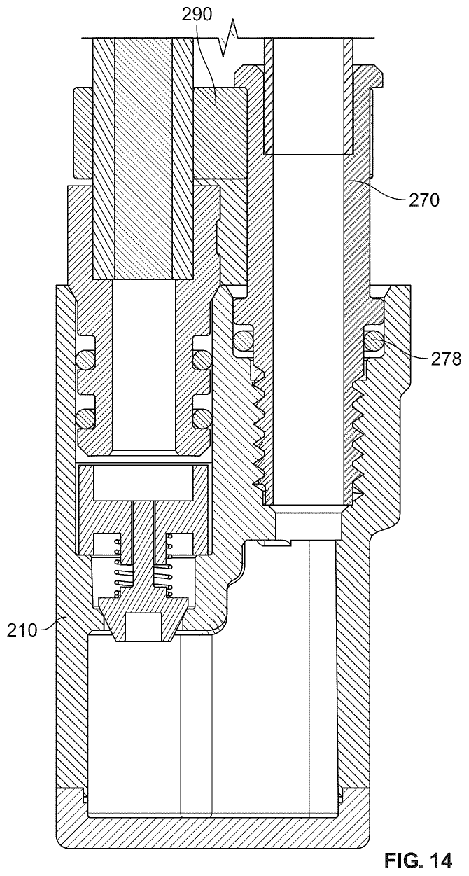

In the example shown, the first section 216 forms a cylindrical opening terminating at a shoulder 217 at the transition between the first and second sections 216, 220. The first section 216 includes a tapered portion 218 adjacent the top side 213 to facilitate entry of the supply adapter 270 into the inlet portion 211. The shoulder 217 provides a stop to prevent a seal 278 (shown in FIGS. 13 and 14), such as an O-ring, positioned within the first section 216 from moving into the second section 220. As will be discussed, the supply adapter 270 may be designed to retain and/or compress the seal 278 within the first section 216 of the inlet portion 211. The first section 216 includes smooth sidewalls to provide sealing against the seal 278.

In the example shown, the second section 220 extends from the shoulder 217 to the interior chamber 229 of the housing 210. The second section 220 of the inlet cavity 215 is threaded to receive corresponding threads of the supply adapter 270. The second section 220 includes a smaller cross-sectional opening than the first section 216.

An outlet cavity 222 extends from the top side 213 and toward the bottom side 214 of the housing 210. The outlet cavity 222 includes first, second, and third sections 223, 224, and 225.

In the example shown, the first section 223 extends from the top side 213 to the second section 224. The first section 223 is designed to allow entry of the valve assembly 230. The valve assembly 230 includes an outlet adapter 240, a stopper holder 250, and a stopper 260 which will be discussed in greater detail below. The first section 223 is shaped to be a close fit with an outer surface of the stopper holder 250. In the example shown, the first section 223 is a cylindrical shaped cavity. The first section 223 terminates at a shoulder 226. The stopper holder 250 is sized to interfere with the shoulder 226, such that the stopper 260 is able to continue into the second and third sections, but not the stopper holder 250, when the valve assembly 230 is inserted into the outlet cavity 222. The outlet adapter 240 is positioned above the stopper holder 250 and only partially enters the first section 223. The first section 223 includes a taper 219 adjacent the top side 213 that is designed to facilitate entry of the valve assembly 230 and to provide a stop for the outlet adapter 240. In some cases, a length of the first section between the top side 213 and the second section 224 determines how far the outlet adapter 240 can travel into the first section 223. In certain instances, the outlet adapter 240 will contact the stopper holder 250 and thereby be prevented from traveling further inward into the outlet cavity 222. In other instances, the taper 219 of the first section may contact a corresponding shoulder of the outlet adapter 240 such that the outlet adapter 240 is prevented from continuing inward into the outlet cavity 222, even when there is clearance within the first section 223.

In the example shown the second section 224 extends from the shoulder 226 of the first section 223 toward the bottom side 214 and terminating at the third section 225. The second section 224 is designed to have a smaller cross-sectional area than the first section 223 as viewed from the top side 213. The second section 224 is designed to have a larger cross-sectional area than the stopper 260 when viewed from the top side 213, such that fluid can flow around the stopper 260 when the stopper 260 is in the open state 430. The second section 224 terminates at a shoulder 227 that is designed to interfere with the stopper 260 when the stopper 260 moves toward and into the third section 225 (a closed state 420).

In the example shown, the third section 225 extends from the second section 224 toward the bottom side 214 and terminates at the interior chamber 229. The third section 225 includes a taper 228 that is adjacent the shoulder 227 of the second section 224. The taper 228 is designed to provide a sealing surface against the stopper 260 when the stopper 260 is partially moved into the third section 225, as the stopper 260 moves from the open state 430 to the closed state 420. In certain examples, an angle of the taper 228 is designed to align with an angle of a sealing surface of the stopper 260 to create better sealing.

The interior chamber 229 is positioned between the inlet cavity 215 and the outlet cavity 222. The interior chamber 229 may take any shape. In certain examples, and as shown in FIG. 8, the interior chamber 229 is U-shaped, such that the inlet cavity 215 and outlet cavity 222 extend generally parallel to each other about a length of the housing 210 between the top side 213 and the bottom side 214. The interior chamber 229 is designed to have a larger cross-sectional area about the fluid flow path such that the interior chamber 229 does not create a flow restriction.

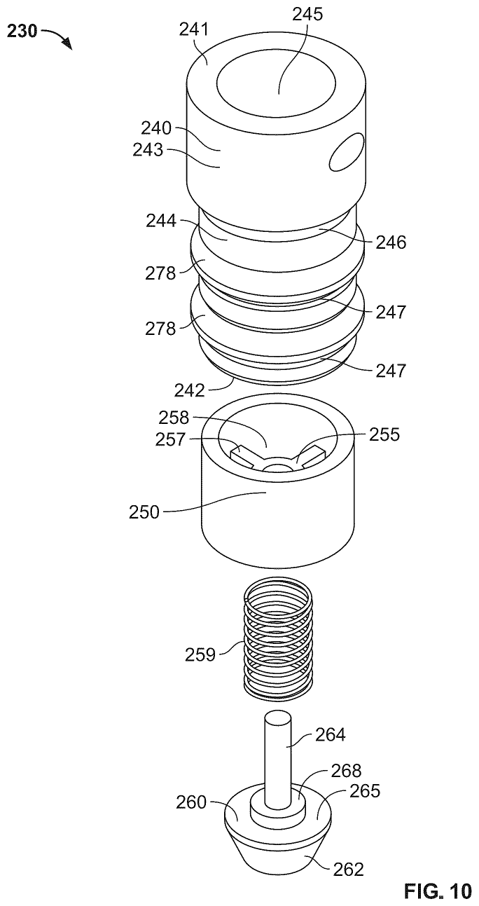

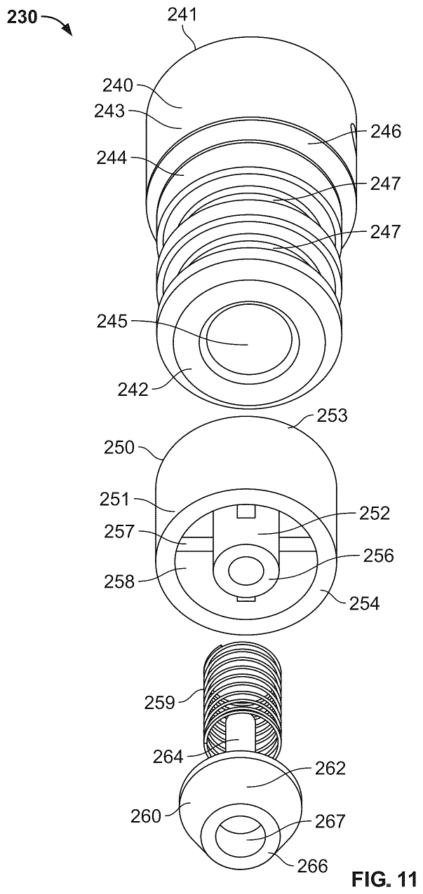

An example valve assembly is shown in FIGS. 10 and 11. The valve assembly 230 includes an outlet adapter 240, a stopper holder 250, a stopper 260, and a spring member 259. The valve assembly 230 is designed to be housed within the housing 210 in the fluid path from the supply to the outlet 130. In general, the valve assembly 230 is designed to move between the open state 430 and the closed state 420. In the open state 430, fluid is able to flow through the housing 210 toward the outlet 130. In the closed state 420, fluid is either limited, attenuated, stopped, or prevented from flowing through the housing 210.

The outlet adapter 240, shown in FIGS. 10 and 11, extends from a first end 241 to a second end 242. The outlet adapter 240 includes a tubular cavity 245 extending though the outlet adapter 240 from the first end 241 to the second end 242. The tubular cavity 245 is cylindrical in shape with a constant diameter about a length of the cavity between the first and second ends 241, 242. The outlet adapter 240 includes an exterior surface between the first and the second ends 241, 242 that is split between an upper portion 243 and a lower portion 244. The upper portion 243 extends from the first end 241 to the lower portion 244. The upper portion 243 has a cylindrical shape and has a larger diameter than the lower portion 244 as measured about the length of the outlet adapter 240. The upper portion 243 is designed to remain on the exterior of the housing 210 when the fluid junction assembly 200 is in the assembled state. A taper 246 transitions between the upper portion 243 and the lower portion 244. The taper 246 is designed to contact the housing 210. The lower portion 244 extends from the upper portion 243 to the second end 242. The lower portion 244 includes two seal channels 247 that are designed to hold a seal 278 on the outlet adapter 240. The seal channels 247 are designed to have a depth sufficient to provide the desired seal contact against the outlet portion 212 of the housing 210, such that fluid is only able to flow about the outlet adapter 240 through the tubular cavity 245. The outlet adapter 240 is designed to connect the outlet pipe 140 with the housing 210 such that fluid may flow through the tubular cavity 245. The outlet adapter 240 may also be designed to, in conjunction with the retainer 290, hold the stopper 260 and stopper holder 250 in the housing 210, such that the valve assembly 230 is detachable from the housing 210 and from the remainder of the fluid junction assembly 200. The outlet adapter 240 is designed to enter, at least partially, the outlet portion 212 of the housing 210. In the example shown, the outlet adapter 240 includes two seals 278 that extend around the lower portion 244 of the outer surface of the outlet adapter 240 (FIG. 10 shows the outlet adapter 240 with the seals 278, and FIG. 11 shows the outlet adapter 240 without the seals 278). The second end 242 of the outlet adapter 240 is designed to contact the stopper holder 250 in the assembled state.

An example stopper holder 250 is shown in FIGS. 10 and 11. The stopper holder 250 is designed to retain the stopper 260 such that the stopper 260 is only able to flow about the direction of the fluid flow. The stopper holder 250 includes an outer tube 251 and an inner tube 252. The stopper holder 250 is also designed to allow the flow of fluid at least between the inner tube 252 and the outer tube 251.

In the example shown, the outer tube 251 includes a first end 253 and a second end 254. The first end 253 contacts the second end 242 of the outlet adapter 240 in the assembled state. The second end 254 contacts the shoulder 226 within the outlet portion 212 that prevents the stopper holder 250 from continuing into the interior chamber 229 of the housing 210.

In the example shown, the inner tube 252 has a first end 255 and a second end 256. The inner tube 252 is designed to slidably retain an attachment structure 264 of the stopper 260 such that the stopper 260 is able to move about the direction of fluid flow but not able to move radially about an inner diameter of the inner tube 252. The inner tube 252 is connected to the outer tube 251 by a plurality of joints 257 extending between an inner diameter of the outer tube 251 to an outer diameter of the inner tube 252.

As illustrated, the joints 257 are structurally sufficient to withstand any forces produced by fluid flow and by movement of the stopper 260 between the open and closed states 430, 420. The joints 257 form a crossbar shape with the inner tube 252 centered at what would be the crossing point, such that gaps 258 form between neighboring joints 257 to allow the flow of fluid through the stopper holder 250. The joints 257 extend at least partially along a length of the inner tube 252 between the first and second ends 255, 256. The cross-sectional area of the gaps 258 (as measured about the direction of fluid flow) is designed to be sufficient to allow a maximum fluid flow through the faucet assembly 100 and to avoid being an area of flow reduction in the faucet assembly 100. In the example shown, the first end 255 of the inner tube 252 is between the first and second ends 253, 254 of the outer tube 251, and the second end 254 of the outer tube 251 is between the first and second ends 255, 256 of the inner tube 252 such that the inner tube 252 begins after the outer tube 251 and ends after the outer tube 251 about a direction moving from the outlet adapter 240 to the stopper 260.

An example stopper is shown in FIGS. 10 and 11. The stopper 260 is designed to engage/contact and disengage a surface in the housing 210 such that in the open state 430, fluid is able to flow through the housing 210 toward the outlet 130. In the closed state 420, fluid is either limited, attenuated, stopped, or prevented from flowing through the housing 210. The stopper 260 includes a stopper head 262 and an attachment structure 264. The stopper head 262 is a frustoconical shape with a base 265 nearest the stopper holder 250 and an apex 266 furthest from the stopper holder 250. The frustoconical shape allows the stopper head 262 to form a seal, or partial seal, about a circular opening of the housing 210. A hole 267 is located at the apex 266 of the stopper head 262 that extends partially into the stopper head 262. The hole 267 is designed to provide a contact surface for fluid as fluid pushes against the stopper head 262 when the valve cartridge 150 is in the activated state. The stopper head 262 also includes a spring member positioning feature 268 that is designed to fit within an inner diameter of the spring member 259. The spring member positioning feature 268 extends from the base 265 and partially toward the stopper holder 250 in the assembled state. The attachment structure 264 extends from the spring member positioning feature 268 and continues away from the stopper head 262 and toward the stopper holder 250. In certain examples, the attachment structure 264 is a shaft or a mandrel designed to fit within the inner tube 252 of the stopper holder 250. The attachment structure 264 forms a close fit with the inner tube 252 of the stopper holder 250 when in an assembled state. The stopper 260 is able to move about the stopper holder 250 about the direction of fluid flow in the valve assembly 230. When the stopper 260 is in the open state 430, the stopper head 262 is nearer the stopper holder 250 than when the stopper 260 is in the closed state 420. In certain examples, the stopper head 262 is made of an elastic material or a sealing material. For example, the stopper head 262 may be made of a rubber or a thermoplastic polymer.

A spring member 259 at least partially surrounds the attachment structure 264. In certain examples, the stopper 260 is spring biased away from the stopper holder 250. In other examples, the stopper 260 may be spring biased toward the stopper holder 250. In the example illustrated, one end of the spring member 259 contacts the second end 256 of the inner tube 252, and a second end of the spring member 259 contacts the base 265 of the stopper head 262 and surrounds the spring member positioning feature 268.

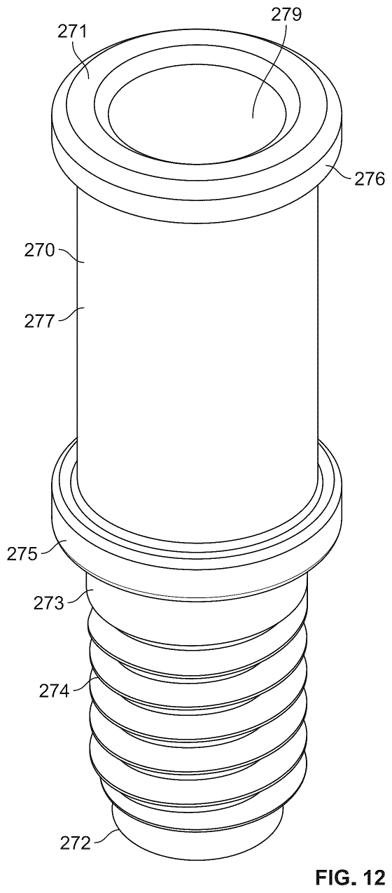

An example supply adapter 270 is shown in FIG. 12. The supply adapter 270 is designed to connect the supply pipe 110 with the housing 210. The supply adapter 270 is tubular in structure and allows fluid flowing from the supply pipe 110 to continue into the housing 210. The supply adapter 270 includes a first end 271 and a second end 272. A through hole 279 extends from the first end 271 through the second end 272, which allows fluid from the supply pipe 110 to flow into the housing 210. In the example shown, an exterior of the supply adapter 270 includes a threaded region 274 extending from the second end 272 and continuing toward the first end 271 and terminating at a sealing portion 273. The threaded region 274 is designed to threadedly engage the second section 220 of the inlet cavity 215. The sealing portion 273 extends from the threaded region 274 and continues to a first raised portion 275. The sealing portion 273 is designed to engage a seal 278 (as seen in FIG. 14). In an assembled state, the seal 278 is held within the first section 216 of the inlet cavity 215 between the shoulder 217 of the inlet cavity 215 and the first raised portion 275 of the supply adapter 270. A second raised portion 276 is adjacent the first end 271. A retaining portion 277 extends between the first and second raised portions 275, 276. The retaining portion 277 is designed to removably engage a retainer 290. The second raised portion 276 is designed to prevent the retainer 290 from moving toward the first end 271. The first and second raised portions 275, 276 have greater outer diameters than the threaded region 274, sealing portion 273, and retaining portion 277.

An example retainer 290 is shown in FIG. 13. The retainer 290 is designed to hold the valve assembly 230 in the housing 210. The retainer 290 connects to the outlet pipe 140 and the supply adapter 270. The retainer 290 includes an outlet pipe retainer 291 and a supply adapter retainer 292. Both the supply adapter retainer 292 and the outlet pipe retainer 291 are designed to be removably connected. The outlet pipe retainer 291 has a C-shaped tubular structure with an open channel 294 that enables the outlet pipe retainer 391 to flex and clip onto the outlet pipe 140. The open channel 294 extends between a first end 296 and a second end 297 of the retainer 290.

In the example shown, the supply adapter retainer 292 has a C-shaped tubular structure with an open channel 295 that enables the supply adapter retainer 292 to flex and clip onto the supply adapter 270. The open channel 295 extends between a first end 296 and a second end 297 of the retainer 290. Open channel 294 and open channel 295 open to different directions about an axis extending between the first end 296 and the second end 297, such that a movement in one direction does not disengage both the outlet pipe retainer 291 and the supply adapter retainer 292. The open channel 294 has a width that is between 15 and 30% of a circumference of the outlet pipe retainer 291. The open channel 295 has a width that is between 15 and 30% of a circumference of the supply adapter retainer 292.

As illustrated, the outlet pipe retainer 291 and the supply adapter retainer 292 are connected at a connection region 293. In an assembled state, the second end 297 of the retainer 290 is adjacent the first end 241 of the outlet adapter 240, such that the valve assembly 230 maintains engagement with the housing 210. The distance between the outlet pipe retainer 291 and the supply adapter retainer 292 may vary with the size of the housing 210.

FIG. 14 shows a cross section of the fluid junction assembly 200 in an assembled state. The supply adapter 270 is held in place by threaded engagement with the housing 210. The outlet adapter 240 is held in place in the housing 210 by retainer 290 because the second raised portion 276 of the supply adapter 270 contacting the supply adapter retainer 292 prevents upward movement of the retainer 290 and thereby prevents the spring member 259 or force from flowing fluid from pushing the outlet adapter 240 away from the housing 210. The retainer 290 and seals 278 overcome a spring force created by spring member 259. Spring member 259 biases the stopper holder 250 toward the outlet adapter 240 and biases the stopper 260 toward the third section 225 of the outlet cavity 222.

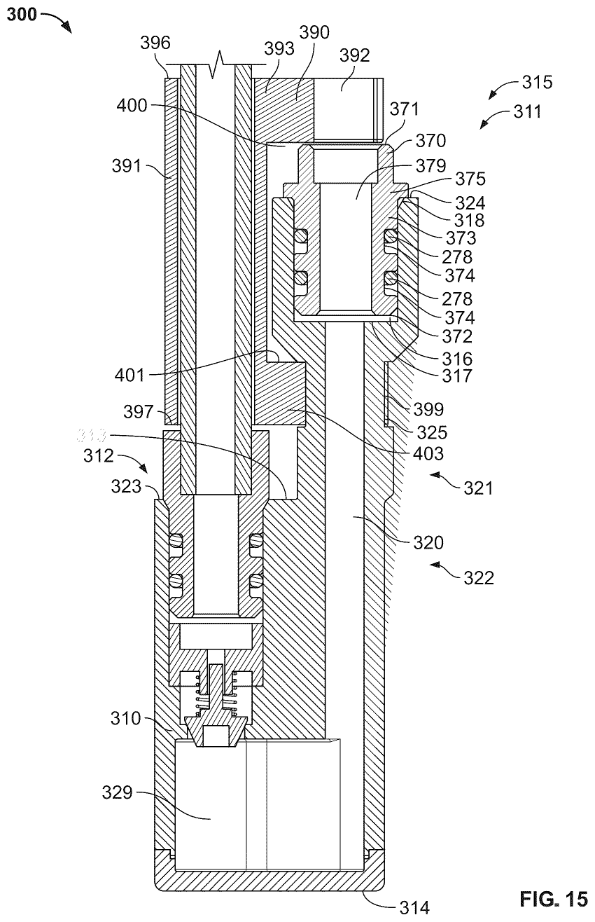

FIG. 15 shows an alternate embodiment of a fluid junction assembly 300. fluid junction assembly 300 is a variation of the fluid junction assembly 200 described above. Many of the characteristics and features of the fluid junction assembly 300 are the same as fluid junction assembly 200 and can be seen by comparing FIG. 14 with FIG. 15. The fluid junction assembly 300 includes a housing 310, a supply adapter 370, and a retainer 390 in addition to the valve assembly 230 already described above.

A cross-section of the housing 310 is shown in FIG. 15, according to an example embodiment. In the example shown, the housing 310 shares many of the features and characteristics of housing 210. The housing 310 provides a space between the valve cartridge 150 and the outlet 130 for the valve assembly 230 to be held and be fluidically connected to the supply fluid. The housing 310 includes an inlet portion 311 and an outlet portion 312. The outlet portion 312 is the same as outlet portion 212. The inlet portion 311 and outlet portion 312 include exterior openings about a top side 313. The top side 313 is stepped such that a length extending from a top inlet side 324 to a bottom side 314 is longer than a length extending from a top outlet side 323 to the bottom side 314.

In housing 310, the inlet portion 311 further defines an inlet cavity 315 that extends from the top inlet side 324 and continues toward the bottom side 314 of the housing 310. The inlet cavity 315 includes a first section 316 that extends between the top inlet side 324 and a second section 320. The first section 316 forms a cylindrical opening terminating at a shoulder 317 at the transition between the first and second sections 316, 320. The first section 316 includes a tapered portion 318 adjacent the top inlet side 324 to facilitate entry of the supply adapter 370 into the inlet portion 311. The first section 316 includes smooth interior sidewalls to provide sealing against the seals 278. The exterior of the first section 316 is a larger diameter than the exterior of an upper portion 321 of the second section 320. The second section extends from the shoulder 317 to an interior chamber 329 of the housing 310. A lower portion 322 of the second section extends from the top outlet side 323 to the interior chamber 329. The second section 320 of the inlet cavity 315 has a smooth tubular interior section. The second section 320 includes a smaller cross-sectional opening than the first section 316 about the direction of fluid flow. The inlet cavity 315 includes an exterior channel 325 wrapping around the second section 320 in the upper portion 321 and configured to engage retainer 390. A width of the exterior channel 325 is sized to be a close fit with a height of the retainer 390.

A cross section of the supply adapter 370 is also shown in FIG. 15, according to an example embodiment. As illustrated, the supply adapter 370 is designed to connect the supply pipe 110 with the housing 310. the supply adapter 370 is tubular in structure and allows fluid flowing from the supply pipe 110 to continue into the housing 310. The supply adapter includes a first end 371 and a second end 372. A through hole 379 extends from the first end 371 and through the second end 372, which allows fluid from supply pipe 110 to flow into the housing 310. An exterior of the supply adapter includes two seal channels 374 wrapping around the through hole 379 and radially about the flow direction in a sealing portion 373. The supply adapter 370 includes a raised portion 375 that has a larger outer diameter than the sealing portion 373. The raised portion 375 acts as a stop when the supply adapter is inserted into the housing 310. The raised portion 375 is designed to contact the top inlet side 324 of the inlet portion 311.

A cross section of the retainer 390 is also shown in FIG. 15, according to an example embodiment. As illustrated, the retainer 390 is designed to hold the valve assembly 230 and the supply adapter 370 in the housing 310. The retainer 390 connects to the outlet pipe 140, the supply pipe 110, and to the housing 310. The retainer includes an outlet pipe retainer 391, a supply pipe retainer 392, and a housing retainer 399.

In the example shown, the outlet pipe retainer 391 has a C-shaped tubular structure with an open channel (not shown) that enables the outlet pipe retainer 391 to flex and clip onto the outlet pipe 140. The open channel of the outlet pipe retainer 391 extends between a first end 396 and a second end 397 of the retainer 390.

In the example shown, the supply pipe retainer 392 has a C-shaped tubular structure with an open channel (not shown) that enables the supply pipe retainer 392 to flex and clip onto the supply pipe 110. The open channel of the supply pipe retainer 392 extends between the first end 396 and an upper intermediate end 400 of the retainer 390. In an assembled state, the second end 397 of the retainer 390 is adjacent the first end 241 of the outlet adapter 240, such that the valve assembly 230 maintains engagement with the housing 310.

In the example shown, the housing retainer 399 has a C-shaped tubular structure with an open channel (not shown) that enables the housing retainer 399 to flex and clip onto the housing 310 at the exterior channel 325. The open channel of the housing retainer 399 extends between a lower intermediate end 401 and the second end 397 of the retainer 390. The outlet pipe retainer 391 and the supply pipe retainer 392 are connected at an upper connection region 393. The outlet pipe retainer 391 and the housing retainer 399 are connected at a lower connection region 403.

In certain examples, the retainer 390 forms a C-shape with the supply pipe retainer 392 extending from the outlet pipe retainer 391 and the housing retainer 399 extending from the outlet pipe retainer 391 parallel to the supply pipe retainer 392. The distance between the upper intermediate end 400 and the lower intermediate end 401 is designed to keep the supply adapter 370 engaged with the housing 310 in the assembled state. The location of the exterior channel 325 of the housing 310, where the housing retainer 399 connects, is designed to keep the outlet adapter 240 engaged with the housing 310 in the assembled state as the outlet pipe retainer 391 and the housing retainer 399 share a lower surface at the second end 397. The distance between the outlet pipe retainer 391 and the supply pipe retainer 392 may vary with the size of the housing 310. Similarly, distance between the outlet pipe retainer 391 and the housing retainer 399 may vary.

In other examples, the retainer may have solid tubular structures for the supply pipe retainer and/or the outlet pipe retainer such that the outlet pipe and/or supply pipe are run through the tubular structure instead of clipped into a C-shaped structure during assembly of the fluid junction assembly.

In certain examples, activation of the valve cartridge 150 allows fluid to flow through at least one of supply pipes 110a and 110b and continue flow through supply pipe 110c. The fluid then flows through the supply adapter 270, 370, and continues into the interior chamber 229, 329. The flowing fluid forms a forward pressure which begins to push against the stopper head 262 at the apex 266 and the hole 267 while the stopper is in the closed state 420 (shown in FIG. 16). Once the force of fluid pushing against the stopper head 262 overcomes the resistive force (e.g., spring force) of spring member 259, the stopper 260 begins to travel toward the stopper holder 250 and move to the open state 430. The attachment structure 264 moves further into the inner tube 252. As the stopper 260 moves into the stopper holder 250, fluid begins to flow around the stopper 260 and through the gaps 258 of the stopper holder 250. Once fluid has moved through the stopper holder, it continues through the tubular cavity 245 and into the outlet pipe (shown in FIG. 17). Eventually fluid travels to the outlet 130. In certain examples, the closed state 420 may be only a partial seal between the stopper 260 and the taper 228 such that limited fluid may flow between the supply pipe 110c and the outlet pipe 140.

In certain examples, deactivation of the valve cartridge 150 stops flow of fluid from the supply pipes 110a, 110b to supply pipe 110c. Because the rest of the faucet assembly has flowing fluid moving toward the outlet at the time the valve cartridge is deactivated, there may be a lag or delay in flow stopping at the outlet 130. Without a fluid junction assembly 200, 300, the lag can create backpressure within the supply pipe 110c and a subsequent noise or movement as fluid is suddenly/rapidly withdrawn into the supply pipe 110c, in the opposite direction of normal fluid flow, due to the backpressure. In certain instances, this backpressure correction (equilibrium between the supply pipe 110c and outlet pipe 140) occurs very rapidly. With the fluid junction assembly 200, 300 present, the weakening flow of fluid toward the outlet 130, caused by the deactivation of the valve cartridge 150, drops below the spring force required to displace the stopper 260 and the stopper 260 returns to the closed state 420 and plugs the third section 225 at the taper 228 of the outlet cavity 222. The stopper 260 forms at least a partial seal that slows the backpressure correction between the supply pipe 110c and the outlet pipe 140.

In certain examples, the stopper 260 enters the closed state 420 before enough backpressure is built up, thereby avoiding a sudden backpressure correction and subsequent noise or movement in the faucet assembly 100 that might otherwise occur, and which might be associated with the backpressure correction. In certain examples, the stopper 260 is moved to the closed state 420 by either a drop in forward pressure within the supply pipe 110c or backpressure in the supply pipe 110c, but fluid in the outlet pipe 140 is prevented from being pulled into the housing 210, 310 by any backpressure that may be present or may subsequently arise, due to the stopper being moved to the closed state 420. In certain examples, the stopper stops, or at least slows, the flow of fluid and/or gas between the supply pipe and outlet pipe (e.g., from the outlet pipe back to the supply pipe). That is, in certain examples, the stopper 260 prevents the flow of fluid and gas between the supply pipe 110c and outlet pipe 140. In other examples, the stopper 260 limits the flow of fluid and gas between the supply pipe 110c and outlet pipe 140 such that equilibrium between the outlet pipe 140 and the supply pipe 110c is achieved over an extended time period and thereby a rapid change between the outlet pipe 140 and supply pipe 110c is avoided. In certain examples, the stopper 260 attenuates the flow of fluid and gas between the supply pipe 110c and outlet pipe 140 such that equilibrium between the outlet pipe 140 and the supply pipe 110c is achieved over an extended time period and thereby a rapid change in pressure between the outlet pipe 140 and the supply pipe 110c is avoided.

In certain examples, the fluid junction assembly 200, 300 may work in a reverse order to slow the pressure change that occurs when the valve cartridge 150 enters the activated state from the deactivated state. The resulting change in pressure is slowed across the supply pipe 110c and outlet pipe 140 by the stopper 260. When the valve cartridge 150 enters the activated state, fluid begins to flow through supply pipe 110c which creates increased pressure within the supply pipe 110c as existing fluid becomes compressed moving towards the outlet pipe 140. Once fluid has travelled through the entire system (i.e., through the supply pipes and through the outlet pipe), pressure reaches an equilibrium. As existing fluid within the supply pipe 110c is compressed by the newly flowing fluid, the pressure builds until the spring force of the spring member 259 is overcome and the stopper 260 moves to the open state. During the transition, when the stopper 260 is moving between the closed state and the open state, the pressure between the supply pipe 110c and the outlet pipe 140 begins to transition toward equilibrium. The stopper 260 slows the pressure transition, thereby avoiding a rapid change in pressure between the outlet pipe and supply pipe.

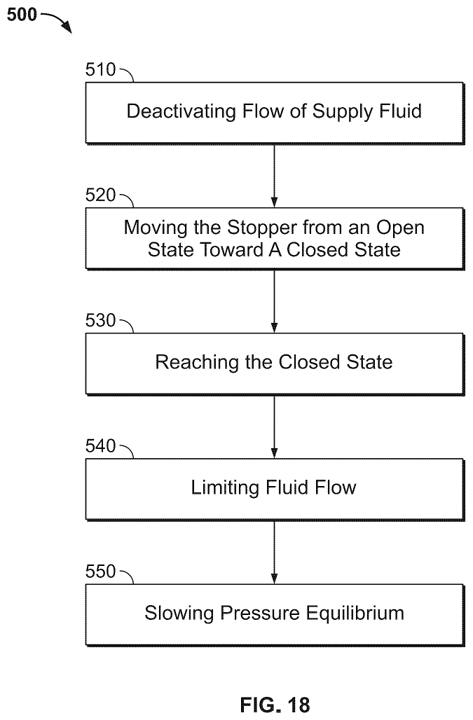

As an example, FIG. 18 shows an operation 500 for dampening fluid flow within a faucet assembly 100. A first operation 510 includes deactivating a flow of supply fluid between a supply and an outlet. The deactivating may be done by moving the valve cartridge 150 to the deactivated state. A second operation 520 includes moving the stopper 260 from the open state 430 toward the closed state 420 as a force created by the flow of supply fluid decreases below a spring force of the spring member 259 attached to the stopper 260, the spring member 259 configured to bias the stopper 260 toward the closed state 420, the stopper 260 positioned within the housing 210, 310 and fluidically connected to the supply and outlet 130. A third operation 530 includes reaching the closed state 420 by creating at least a partial seal within the housing 210, 310 through contact between the stopper 260 and the housing 210, 310. A fourth operation 540 includes dampening fluid flow between the inlet portion 211, 311 of the housing 210, 310 and the outlet portion 212, 312 of the housing 210, 310 as a result of at least a partial seal within the housing 210, 310. A fifth operation 550 includes slowing pressure equilibrium between the inlet portion 211, 311 and the outlet portion 212, 312 of the housing 210, 310. In certain examples, the fourth operation 540 of dampening fluid flow includes limiting flow of supply fluid and limiting flow of gas within the faucet assembly. In certain examples, the fourth operation 540 of dampening fluid flow includes preventing fluid flow, and the fifth operation 550 of slowing pressure equilibrium includes preventing pressure equilibrium.

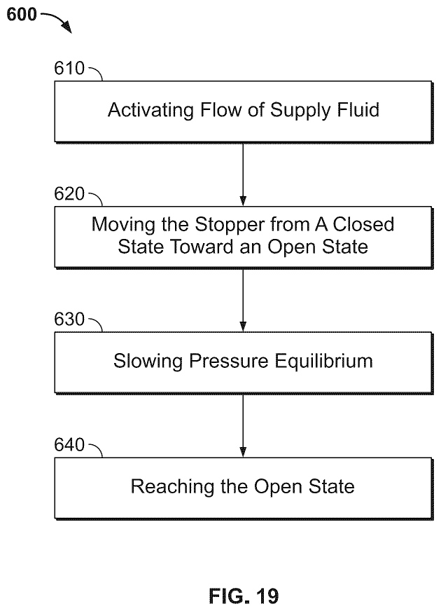

As an example, FIG. 19 shows an operation 600 for slowing pressure equilibrium within a faucet assembly 100. A first operation 610 involves activating a flow of supply fluid between a supply and an outlet. The activating may be done by moving the valve cartridge 150 to the activated state. A second operation 620 includes moving the stopper 260 from the closed state 420 toward the open state 430 as a force created by the flow of supply fluid increases above a spring force of the spring member 259 attached to the stopper 260, the spring member 259 configured to bias the stopper 260 toward the closed state 420, the stopper 260 positioned within the housing 210, 310 and fluidically connected to the supply and outlet 130. A third operation 630 includes slowing pressure equilibrium between the inlet portion 211, 311 and the outlet portion 212, 312 of the housing 210, 310. A fourth operation 640 includes reaching the open state 430 by removing an at least partial seal within the housing 210, 310 between the stopper 260 and the housing 210, 310.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A fluid junction assembly for a faucet assembly comprising:
a housing having an inlet portion configured to receive a supply fluid and an outlet portion configured to output the supply fluid; and
a valve assembly positioned along a fluid path between the inlet portion and the outlet portion, the valve assembly having an open state allowing fluid flow when the supply fluid is flowing from the inlet portion toward the outlet portion and a closed state limiting fluid flow when the supply fluid is not flowing from the inlet portion toward the outlet portion.

2. The fluid junction assembly of claim 1, wherein the housing further includes an interior chamber between and fluidically connecting the inlet portion and the outlet portion.

3. The fluid junction assembly of claim 1, wherein the fluid junction assembly further includes a supply adapter positioned at least partially within the inlet portion of the housing and configured to connect a supply pipe to the housing.

4. The fluid junction assembly of claim 1, wherein the valve assembly includes an outlet adapter positioned at least partially within the outlet portion of the housing and configured to connect an outlet pipe to the housing.

5. The fluid junction assembly of claim 1, wherein the valve assembly is spring biased toward the closed state.

6. The fluid junction assembly of claim 1, wherein the valve assembly further includes a stopper, wherein the stopper contacts the housing in the closed state, and wherein the stopper does not contact the housing in the open state.

7. The fluid junction assembly of claim 6, wherein valve assembly further includes a stopper holder and a spring member, wherein the stopper holder is configured to slidably retain an attachment structure of the stopper, wherein the spring member at least partially surrounds the attachment structure and biases the stopper away from the stopper holder.

8. The fluid junction assembly of claim 1, wherein the fluid junction assembly further includes a retainer with at least an outlet pipe retainer, wherein the outlet pipe retainer surrounds a portion of the outlet pipe adjacent an outlet adapter, wherein the retainer is configured to maintain engagement between the valve assembly and the housing.

9. A faucet assembly comprising:
a faucet body including a valve cartridge and an outlet, the valve cartridge connecting to a fluid supply, the valve cartridge configured to control flow of a supply fluid from the fluid supply to the outlet, the valve cartridge having an activated state allowing the supply fluid to flow toward the outlet and a deactivated state preventing the supply fluid from flowing toward the outlet;
a fluid junction assembly comprising:
a housing having an inlet portion and an outlet portion; and
a valve assembly positioned within the housing and fluidically connected to the inlet portion and the outlet portion, the valve assembly including a stopper, the stopper having an open state allowing the supply fluid to flow between the inlet portion and the outlet portion when the valve cartridge is in the activated state and a closed state limiting a fluid flow between the inlet portion and the outlet portion when the valve cartridge is in the deactivated state, the stopper being spring biased toward the closed state;
a supply pipe extending between the valve cartridge and the inlet portion of the housing, the supply pipe configured to carry the supply fluid from the valve cartridge to the housing; and
an outlet pipe extending between the outlet portion of the housing and the outlet of the faucet body, the outlet pipe configured to carry the supply fluid from the housing to the outlet.

10. The faucet assembly of claim 9, wherein the valve assembly includes a spring member configured to bias the stopper toward the closed state.

11. The faucet assembly of claim 10, wherein the spring member at least partially surrounds an attachment structure of the stopper, wherein the attachment structure of the stopper slidably engages a stopper holder, wherein the spring member extends between an end of the stopper holder and a base of the stopper.

12. The faucet assembly of claim 11, wherein the stopper and the stopper holder are positioned within an outlet cavity, the outlet cavity being part of the outlet portion of the housing.

13. The faucet assembly of claim 10, wherein the spring member has a spring force that is weaker than a force of flowing supply fluid acting against a stopper head of the stopper.

14. The faucet assembly of claim 13, wherein the stopper head includes a hole extending partially between an apex of the stopper head and a base of the stopper head, wherein the hole is configured to contact the flowing supply fluid when the valve cartridge is in the activated state.

15. The faucet assembly of claim 9, wherein the valve assembly includes an outlet adapter configured to connect the outlet pipe with the housing, wherein the fluid junction assembly further includes a supply adapter configured to connect the supply pipe with the housing.

16. The faucet assembly of claim 15, wherein the fluid junction assembly further includes a retainer, the retainer including an outlet pipe retainer configured to removably attach to the outlet pipe and a supply adapter retainer configured to removably attach to the supply adapter, wherein contact between the outlet adapter and the housing is maintained by the retainer.

17. The faucet assembly of claim 15, wherein the fluid junction assembly further includes a retainer, the retainer including an outlet pipe retainer configured to removably attach to the outlet pipe, a supply pipe retainer configured to removably attach to the supply pipe, and a housing retainer configured to removably attach to the housing, wherein contact between the outlet adapter and the housing is maintained by the retainer, wherein contact between the supply adapter and the housing is maintained by the retainer.

18. The faucet assembly of claim 9, wherein the fluid junction assembly is positioned externally to the faucet body.

19. A method for dampening fluid flow within a faucet assembly comprising:
in response to reducing a flow of supply fluid within a faucet assembly between a supply pipe and an outlet, moving a stopper from an open state toward a closed state as a forward pressure through a fluid path created by the flow of supply fluid decreases below a spring force of a spring member attached to the stopper, the spring member configured to bias the stopper toward the closed state, the stopper positioned within a housing spaced apart from a faucet body of the faucet assembly and positioned along a fluid path between the supply pipe and the outlet.

20. The method of claim 19, further comprising:
reaching the closed state by creating at least a partial seal within the housing through contact between the stopper and the housing;
dampening fluid flow between an inlet portion of the housing and an outlet portion of the housing as a result of the at least a partial seal within the housing; and
slowing pressure equilibrium between the inlet portion and the outlet portion of the housing.
